(19) United States
(12) Patent Application Publication
(10) Pub. No.: US 2026/0352831 A1
(43) Pub. Date: Nov. 5, 2026

(54) Method and device for encoding and decoding images

(71) Applicant: ORANGE, Issy-les-Moulineaux (FR)

(72) Inventors: Theo LADUNE, CHATILLON (FR); Félix HENRY, CHATILLON (FR); Pierrick PHILIPPE, CHATILLON (FR); Gordon CLARE, CHATILLON (FR)

(21) Appl. No.: 19/487,115

(22) PCT Filed: May 7, 2024
(86) PCT No.: PCT/EP2024/062653

§ 371 Date: Nov. 24, 2025

(30) Foreign Application Priority Data
May 24, 2023 (FR) FR2305152

(51) Int. Cl. H04N 19/132; H04N 19/136; H04N 19/436; H04N 19/463

(52) U.S. Cl. CPC H04N 19/132; H04N 19/136; H04N 19/436; H04N 19/463

(57) ABSTRACT

A method and device for encoding and decoding images having a plurality of samples to be encoded or decoded. The decoding method includes: decoding a group of feature maps representative of the current image, the group including at least one feature map having a lower resolution than the resolution of the input image, which map is referred to as a lower resolution map; obtaining a set of parameters representative of at least one neural network referred to as an oversampling neural network; oversampling the at least one lower resolution feature map using the oversampling network to obtain an oversampled map at the resolution of the at least one image; generating the at least one image from the at least one oversampled map.

### PRIOR ART

The invention relates to the general field of the encoding of sequences of digital images. It relates more particularly to the compression of digital videos.

Digital videos generally undergo a source encoding aiming to compress them in order to limit the resources needed for their transmission and/or their storage. Numerous encoding standards exist, such as the standards from the bodies ITU/MPEG (H.264/AVC, H.265/HEVC, H.266/VVC, etc.) together with their extensions (MVC, SVC, 3D-HEVC, etc.).

Since video formats are continually evolving in order to compress them even more and to adapt to the variety of expected formats and communications networks, the prediction possibilities are becoming ever more extensive and the conventional encoding and decoding algorithms very complex.

In addition to these conventional approaches provided by the compression standards (MPEG, ITU), approaches based on artificial intelligence, and notably neural techniques, are increasingly being developed.

Some of these neural approaches may be seen as a simple extension of the notion of competition of the above-mentioned compression techniques, such as the prediction and transformation mode competition in video encoding.

Other approaches use the “self-encoder” concept. Self-encoders are training algorithms based on artificial neural networks, which allow a new representation of a set of data to be constructed. The architecture of a self-encoder is composed of two parts: the encoder and the decoder. The encoder is composed of a set of layers of neurons, which process the data in order to construct new representations referred to as “encoded”, also referred to as “latent representations”. In turn, the layers of neurons of the decoder receive these representations and filter them in order to try and reconstruct the starting data. The differences between the reconstructed data and the initial data allow the error committed by the self-encoder to be measured. The training consists in modifying the parameters of the self-encoder in order to reduce the reconstruction error measured on the various samples from the data set. The performance of such systems using a self-encoder comes at the expense of a considerable increase in the memory required and in complexity compared to the conventional approaches such as provided by the compression standards. They may have millions of parameters and may require of the order of a million MAC (multiplication-accumulation) operations in order to decode a single pixel. This makes the decoders much more complex than the conventional decoders, which could hinder the adoption of the compression based on the training. Moreover, the neural networks used in the coding and in the decoding are different. The document US 2022/0385907 describes such a self-encoder system.

More recently, a simple image encoding technique based on a neural network has been described in the article “Compression with Implicit Neural representations” by Emilien Dupont et al. (arXiv:2103.03123). The encoding technique provided consists in adjusting a neural network to an image, quantifying the weights of the network and transmitting them. At the time of the decoding, the neural network is evaluated at each pixel position in order to reconstruct the image. Such a technique however remains inefficient in terms of compression.

The document US 2022/0385907 also describes an encoding and decoding system based on the use of such implicit neural representations.

However, there exists a need for a solution allowing a sequence of images to be encoded/compressed in a simple and efficient manner.

### DESCRIPTION OF THE INVENTION

The invention is aimed at a method for encoding at least one image comprising a plurality of samples to be encoded, comprising the following steps:
a construction step, comprising the sub-steps for:
construction of a group of feature maps comprising at least one feature map with a lower resolution than the resolution of the input image, referred to as lower resolution map;
oversampling of said at least one lower resolution feature map using at least one oversampling artificial neural network defined by one set of oversampling parameters so as to obtain an oversampled map at the resolution of said at least one image;
generation of said at least one image based on said at least one oversampled map;
updating at least one value from one of said feature maps from said group and/or at least one oversampling parameter, as a function of an encoding performance measurement,
a step for encoding said group of feature maps and said set of oversampling parameters.

The invention is also aimed at a method for decoding at least one image, from a binary stream comprising a plurality of samples to be decoded, comprising the following steps:
decoding a group of feature maps representative of the current image, said group comprising at least one feature map with a lower resolution than the resolution of the input image, referred to as lower resolution map;
obtaining a set of oversampling parameters representative of at least one neural network, referred to as oversampling neural network;
oversampling of said at least one lower resolution feature map using said at least one oversampling network so as to obtain an oversampled map at the resolution of said at least one image.
generation of said at least one image from said at least one oversampled map.

In the sense of the invention, encoding, or “coding”, is understood to mean the operation which consists in representing a set of samples, or pixels, in a compact form carried for example by a digital binary stream. Decoding is understood to mean the operation which consists in processing a digital binary stream so as to render decoded samples, for example of a digital image or of a plurality of digital images.

“Image” is understood to mean a two-dimensional digital image comprising one or more components (color, depth, views, etc.).

“At least one image” is understood to mean a plurality of ordered two-dimensional images, for example in time sequence in the case of a video. According to another example, the images may be views of the same scene represented as multi-views. According to another example, the images may be a plurality of multi-view images in time sequence (immersive video).

“Sample” is understood to mean a value taken from an image. The sampling of a signal produces a series of discrete values called samples. In the case of an image signal, the sample takes the name pixel which may for example be a color pixel conventionally represented by a triplet of values, for example (R, G, B) or (Y, U, V). The position of the sample may be identified by its coordinates as abscissa (x) and ordinate (y) within the image.

“Feature map” is understood to mean an abstract representation of an image or of a sequence of images, comprising a plurality of variable scalar data, which are also referred to as characteristic values, for example real numbers or integer numbers, signed or otherwise. The abstract representation of an image or of a sequence may therefore comprise several feature maps. The abstract representation of several images may also correspond to a single feature map.

“Oversampling of the feature maps” is understood to mean an operation which allows the values of a first map to be transformed into values of a second map. The first map, intended for the encoding (respectively, for the decoding), is any given map. The second map, referred to as oversampled map, is at a higher resolution. For example, it may have the same resolution as the input images, in other words it comprises as many values as an input image (respectively, image to be decoded) comprises of samples (N).

“Neural network”, or “oversampling neural network”, is understood to mean a neural network such as a convolutional neural network, a multilayer perceptron, etc. The neural network is defined for example by a plurality of layers of artificial neurons and by a set of activation, weighting and for addition functions (for example, a layer may calculate y=f(Ax+b), where y and b are vectors of dimension N, x is a vector of dimension M, A is a matrix of dimension MxN, and f is the activation function).

“Parameter of the neural network” is understood to mean one of the values which characterize the neural network, for example a weight associated with one of the neurons (filter coefficient, value of a matrix, weighting, bias, value affecting the operation of the non-linearity, etc.).

“Generation of said at least one image” is understood to mean a step which is aimed at reconstructing the decoded samples of the image.

The samples are generated from the oversampled feature maps. The generation of a sample is thus advantageously simplified, notably in the case where the oversampled feature maps are at the dimension of the image, because its extraction is facilitated. Moreover, the oversampling neural network is capable of automatically adapting to the nature of the maps and of the image.

“Measurement of performance” is understood to mean a measurement between at least one value of a sample to be encoded and a decoded value of said sample. The measurement may for example evaluate a distortion, or a perceptive error. It may be carried out on one sample or a plurality of samples (for example, the current samples, or the current images, etc.). The measurement may also comprise a measurement of the rate, notably associated with the encoding of the neural network and/or with the encoding of the feature maps of the group. The measurement may be a joint measurement between the rate and the distortion through their weighting. As is well known from the prior art, a minimization of the value of this measurement is generally carried out until a target value is reached.

“Construction step” is understood to mean a step which is aimed at constructing the parameters representative of the image, notably the values of the feature maps and the parameters of the neural network, prior to their effective encoding. The construction sub-steps may be iterated as many times as needed in order to obtain an acceptable performance measurement.

Generally speaking, it is considered that the steps of an encoding or decoding method should not be interpreted as being linked to a notion of succession over time. In other words, the steps may be performed in an order different from that indicated in the independent encoding or decoding claim, or even in parallel.

The encoding method according to the invention carries out a construction of the encoding parameters, based on one input image or sequence of images, by training a neural network on feature maps which may be at the resolution of the input images, or at a lower resolution. During the training, or construction, the parameters of the neural network and the values of the feature maps are updated as a function of a measurement of performance, for example of the rate-distortion type. When the training is finished, in other words the measurement of performance obtained is satisfactory, the effective encoding of the parameters of the oversampling neural network and of the values of the feature maps may be carried out and the result stored in memory or transmitted to the decoder.

Advantageously, the training process allows the parameters of the oversampling neural network and/or the values of the feature maps to be refined until a suitable representation in terms of performance is obtained, for example a desired balance between the rate generated and the distortion suffered by the input image or sequence of images during encoding. The training of the values of the feature maps and of the parameters of the oversampling neural network may be combined. Advantageously, the encoding method according to the invention allows the signal to be compressed efficiently.

Advantageously, the compression of the feature maps is efficient since at least one of the feature maps to be encoded (respectively, decoded) comprises fewer values than if it were at the resolution of the signal. For example, in the case of a digital image, one of the feature maps to be encoded (respectively, decoded) may be at the resolution ½, in other words it comprises half as many values as abscissa and as ordinate than the input image comprises of samples, i.e. in total four times fewer values than a feature map at the resolution of the image. In contrast, the oversampled feature map is at a higher resolution, for example with a resolution identical to that of the signal. The oversampling allows the same number of values to be obtained in this transformed map as the input signal (respectively, signal to be decoded) comprises of samples.

Advantageously, the decoding method is simple since it suffices to decode the feature maps associated with an image or with a group of images, and to obtain the oversampling neural network, in order to reconstitute a decoded version of the current image or of the group of current images.

Such an oversampling neural network may advantageously have a very simple structure with few parameters and few operations per sample.

Moreover, the decoding may be performed sample by sample, in a progressive manner.

According to embodiments of the encoding or decoding method:
At least a part of the set of oversampling parameters is decoded from data of said binary stream (respectively, encoded into the binary stream); advantageously according to this embodiment, the parameters of the neural network are transmitted in the stream. The module may be transmitted in a quantified form and encoded in a compact form by means of any quantifier and entropy encoder accessible to those skilled in the art. A format analogous to that of the standard MPEG-7 NNR may be employed.
At least a part of the set of oversampling parameters is obtained from predetermined values; advantageously according to this embodiment, the parameters of the neural network are obtained, for example, from a network or from a storage memory.
At least a part of the set of oversampling parameters is decoded (respectively, encoded) as a function of reference parameters. Advantageously according to this embodiment, the parameters of the neural network are decoded by taking into account reference parameters which may be stored in a memory accessible to the decoder, or obtained from a network. Thus, the storage space or the rate of transmission over the network may be efficiently reduced: some parameters may be encoded in a complementary manner, others may not be encoded at all since they are available in the reference parameters. According to variant embodiments, which may be combined together:
the reference parameters may constitute a set of variants of an oversampling network: convolution type, attention modules, etc. Thus, only these parameters need to be known to the decoder. They may for example be encoded, inserted into the stream and decoded by the decoder which can reconstitute, using reference parameters, the at least one oversampling network.
the oversampling parameters are encoded in a manner complementary to the parameters of a reference network. Thus, it will suffice for the decoder to decode these residual parameters then to correct them by addition, multiplication (or combination in any other known manner) with those of the reference neural network.
a part of the parameters of a reference network is re-used for the oversampling network. For example, a complete layer of the oversampling network may be copied from the reference network, and the parameters of this layer are therefore neither encoded, nor transmitted, nor decoded.
a reference network indicator is transmitted and decoded in the stream. It is thus possible to indicate a network to be used in the decoding from amongst a plurality of possible networks known to the decoder.
Said set of oversampling parameters is representative of a plurality of oversampling neural networks, an oversampling neural network being used for oversampling at least one lower resolution feature map from the group of feature maps. Advantageously, according to this embodiment, a plurality of oversampling neural networks may be decoded, each of them being intended for the decoding of one or more maps. Thus, the oversampling of the various maps may be implemented separately. According to one variant embodiment, at least two oversampling neural networks are used for oversampling the same lower resolution feature map from the group of feature maps.
An oversampling neural network is used to oversample at least two feature maps of lower resolution from the group of feature maps.
Said oversampling neural network is used to oversample at least one map already oversampled from the group of feature maps. Advantageously according to this embodiment, it is possible to use the same oversampling network in cascade mode. For example, an oversampling by a factor four in each dimension may be carried out by cascading two networks for oversampling by a factor two. This limits the cost of transmission and storage of the data and allows the modules to be implemented by the encoder and the decoder, and hence the algorithmic complexity, the space occupied in memory, etc., to be limited.
Said at least one lower resolution feature map is oversampled in at least two dimensions, and a separate oversampling is used for each dimension. Advantageously according to this embodiment, the cost of transmission and the complexity are reduced by the use of separable oversampling transformations (for example, convolution).
The generation of said at least one image uses a synthesis neural network capable of generating a sample of the image to be decoded using data extracted from the oversampled feature maps at positions defined by that of said sample within the image. Advantageously according to this embodiment, the encoding method implements a production of the encoded values by training a neural network on vectors of values extracted from the feature maps, associated with a position of a sample to be encoded. When the training is finished, in other words the measurement of performance obtained is satisfactory, the effective encoding of the parameters of the synthesis neural network may be carried out and stored in memory or transmitted to the decoder. The decoding method is simple since it suffices to decode the feature maps, the oversampling neural network and the synthesis neural network in order to reconstitute a decoded version of the image signal. According to variants of this embodiment:
such a synthesis network comprises an MLP. Such neural network is advantageously of very simple structure with few parameters. Moreover, the decoding may be carried out sample by sample, in a progressive manner.
The synthesis network comprises filtering elements of the convolution type.
The construction of the data vector comprises a sub-step for extraction of a value from said at least one oversampled feature map at a position identical to that of the current sample in the signal to be encoded (respectively, decoded). Advantageously, this method is simple to implement. For example, if there are J oversampled feature maps with the same resolution as the signal, a simple extraction of the values from the maps at the coordinates of the current sample (at the same abscissa and the same ordinate in the feature map) allows the construction of a data vector with J elements to be applied at the input of the synthesis neural network so as to obtain a sample or a plurality of samples at the output.
At least one of said feature maps has an identical resolution to that of the signal to be encoded (respectively, decoded). Advantageously according to this embodiment, at least one of the feature maps, with the same resolution as the input signal to be encoded (respectively, to be decoded), enables a high fidelity and the conservation of the details of the initial resolution of the signal. The oversampling, in this case, conserves the number of values of the feature map; it may be reduced to the identity function.
At least one oversampled map is obtained from a plurality of feature maps of lower resolution.
Several decoded maps are used to produce several oversampled maps.

In a correlated manner, the invention is also aimed at an encoding device and a decoding device.

The features and advantages of the encoding or decoding method are applicable in the same manner to the encoding or decoding device according to the invention and vice versa.

The invention is also aimed at a computer program on a recording medium, this program being able to be implemented in a computer or a control device according to the invention. This program comprises instructions adapted to the implementation of the corresponding method. This program may use any given programming language and may take the form of source code, object code, or of code intermediate between source code and object code, such as in a partially compiled form, or in any other desired form.

The invention is also aimed at an information medium or a recording medium readable by a computer, and comprising instructions of a computer program mentioned hereinabove. The information or recording media may be any given entity or device capable of storing the programs. For example, the media may comprise a storage means, such as a ROM, for example a CD-ROM or a microelectronic circuit ROM, or else a magnetic recording means, for example a diskette or a hard disk, a DNA sequence, or a flash memory. On the other hand, the information or recording means may be transmissible media such as an electrical or optical signal, which may be carried via an electrical or optical cable, by radio link, by wireless optical link or by other means.

The program according to the invention may, in particular, be up/downloaded over a network of the Internet type.

Alternatively, each information or recording medium may be an integrated circuit in which the program is incorporated, the circuit being designed to execute or to be used in the execution of a method according to the invention.

### BRIEF DESCRIPTION OF THE DRAWINGS

Other features and advantages of the present invention will become apparent from the description presented hereinbelow, with reference to the appended drawings which illustrate non-limiting exemplary embodiments of it.

FIG. 1 shows schematically an encoding device used in the framework of the invention;

FIG. 2 shows schematically a decoding device used in the framework of the invention;

FIG. 3 shows schematically an oversampling artificial neural network used in the framework of the invention.

FIG. 4 illustrates one example of an oversampling module used in the framework of the invention.

FIG. 5 shows other examples of implementation of the oversampling module used in the framework of the invention.

FIG. 6 is a flow diagram showing one example of an encoding method which may be implemented by the encoding device in FIG. 1.

FIG. 7 shows an illustration of an encoding method used in one embodiment of the invention.

FIG. 8 is a flow diagram showing one example of a decoding method which may be implemented by the decoding device in FIG. 2.

FIG. 9 shows an illustration of a decoding method used in one embodiment of the invention.

### DESCRIPTION OF THE EMBODIMENTS

FIG. 1 shows schematically a device for encoding digital images ENC.

The encoding device ENC in FIG. 1 receives at the input a succession of samples to be encoded, denoted Pₙ, for example a succession over time of audio samples, or a set of image data denoted I(Pₙ). In this second case, the image signal I(Pₙ) may represent a two-dimensional image, or a plurality of two-dimensional images (video, color components, stereoscopic components, multiscopic components, etc.). Pₙ denotes a sample n of the input signal comprising N samples. In one embodiment, the signal is a color image signal represented by means of at least one two-dimensional representation, such as a matrix of pixels, of width W and of height H (with N=W×H), each pixel comprising a red (R), green (G) and blue (B) component or, as a variant, a luminance component (Y) and at least one chrominance component. The location of each pixel is defined by its coordinates as abscissa and ordinate (x and y) in the image. In one embodiment, the image is in gray scale represented by means of a two-dimensional representation, such as a matrix of pixels, each pixel comprising a gray-scale, or luminance, component.

This encoding device ENC comprises a module INIT for generating the initial feature maps, a quantification module Q, a module UP for oversampling the feature maps and a module PROD for synthesizing a signal, according to the example shown a digital image I(P′ₙ), a module FMC for encoding the feature maps, a neural network encoding module NNC, a signal encoding module PRC, a module EVAL for evaluating a performance function, and an updating module MAJ.

An oversampling network of artificial neurons used in the encoding, contained in the module UP, and an oversampling network of artificial neurons used in the decoding, contained in the module UP′, are defined by an identical structure, comprising for example a plurality of layers of artificial neurons, and by a set of weights and activation functions respectively associated with the artificial neurons of the network in question.

During the process of training, or of construction, of the encoding, in other words for as long as the step for evaluation of a performance is not satisfactory, the encoding modules (FMC, NNC, optionally PRC) perform a simulation of encoding, followed by a decoding, intended for the evaluation module. Subsequently, they perform the effective encoding of the values of the maps FMᵢ, of the parameters of the oversampling neural network WUₖ and, optionally, of the encoding parameters of the synthesis module PROD. In a known manner, the encoding simulation may be identical to the effective encoding, or may form an approximation to it.

Each feature map contains scalar data, according to the definition of a feature map previously given, and there are M feature maps. It is however possible to organize the characteristic values differently, for example by forming a single signal comprising, for each sample, a vector of M scalar values, with no loss of generality. Even if the data are organized differently, in the following part of the document it is considered that there are M feature maps. The maps encoded by the module FMC for a current image (or plurality of images) are denoted FMcᵢ. If necessary, the encoding module FMC quantifies the values of the feature maps using a quantifier to generate an ordered collection of quantified values. Then, the encoding module compresses the quantified data, for example using an entropy encoder.

The module Q optionally performs a quantification. The module Q produces the maps FMqᵢ. During the encoding step, a quantification is indispensable to the correct operation of the system if the feature maps comprise for example floating, or real, values. It is necessary to quantify them before encoding them and/or feeding them to the input of the oversampling neural network. At the decoding, on the other hand, the inverse quantification is not necessary, depending on the embodiments.

The module UP carries out an oversampling of the feature maps FM(q)ᵢ. This module comprises oversampling parameters WUₖ representative of an oversampling neural network. This oversampling is carried out on at least one map, obtained after the module Q, with a lower resolution than the resolution of the image. Some maps may not require oversampling, notably if their resolution is equal to that of the image to be encoded. Such maps are not processed by the module UP (or the module UP is reduced to the identity function). A set of characteristic maps FMUi, comprising the maps effectively oversampled and the maps not oversampled for which FMUi=FMqᵢ, is obtained at the output of the module UP.

According to embodiments, the module UP may be a neural network of the convolutional type, comprising at least one convolution layer. Each convolution layer may comprise non-linearities of the type rectification, arc tangent, sigmoid, etc. It may also comprise a post-processing module of the convolutional or convolutional with residual type or an attention module. The module UP may also comprise several neural networks.

The module PROD is a synthesis module, for example a neural network or an inverse linear transformation (wavelet, DCT, etc.) defined by its synthesis parameters WSₖ, designed to process the characteristic maps FMUᵢ at the input so as to generate at the output the synthesized image (encoded then decoded) I(P′ₙ). The image samples decoded by the module PROD are denoted P′ₙ.

According to one embodiment, the synthesis module is a bank of filters, the parameters WUₖ are the parameters of the filters, and the synthesized image at the output results from the application of the bank of filters to the feature maps FMUᵢ.

According to one embodiment, the synthesis module is a synthesis neural network and for each sample to be decoded, the synthesis parameters WSₖ are the parameters of the synthesis neural network.

According to another embodiment, the neural network is of the convolutional type or of the multilayer perceptron (MLP) type. A combination of these two types of topology is also possible. With a view to limiting the number of arithmetic operations, an MLP is placed upstream of a convolution module. The synthesis module may comprise a post-processing module of the convolutional or convolution with residual type applied to a signal (R, G, B) or (Y, U, V).

A neural network of the module PROD may behave as the aforementioned implicit neural networks: it may advantageously process vectors coming from co-localized pixels coming from oversampled feature maps. In this case, the positional decoding of the samples may be carried out independently, which provides an advantage in terms of parallelization of the decoding. A vector (P′ₙ) representative of the sample Pₙ to be encoded is generated at the output as a function of its position in the image. According to one embodiment, the output vector is the triplet (R, G, B) of the decoded pixel P′ₙ, or the triplet (Y, U, V) of the decoded pixel P′ₙ when the image is in the format YUV 444, or a vector comprising four values Y, one value U and one value V, able to represent four decoded pixels P′ₙ when the image is in YUV 420 format.

The oversampling parameters WUₖ of the oversampling neural network encoded by the module NNC are denoted WUcₖ.

The synthesis parameters WSₖ of the synthesis module encoded by the module PRC are denoted WScₖ.

When all the samples Pₙ of the signal have been encoded then decoded, this provides a reconstructed signal I(P′ₙ), according to one example an image I comprising N decoded samples in the form of N vectors.

The module EVAL carries out an evaluation and minimization of an encoding performance. The evaluation function is for example of the rate-distortion type. It aims to minimize the differences between the representation of the current image I(Pₙ) at the input and its representation I(P′ₙ) at the output, while at the same time optimizing the quantity of data to be encoded. The minimization may be implemented by a gradient descent, or any other method of optimization available to those skilled in the art.

The module MAJ carries out an update of the values of the maps FMᵢ to be encoded of the current image, depending on the results of the performance function.

Once the training of the encoder is finished, the parameters of the oversampling network are encoded, either without losses, in which case the neural network UP′ of the decoder is identical to UP, or with losses, in which case the network UP′ may be slightly different from UP. The values of the feature maps, FMᵢ, are also encoded in the form of encoded data FMcᵢ, for example via an entropy encoder. The parameters of the synthesis module WScₖ are optionally encoded.

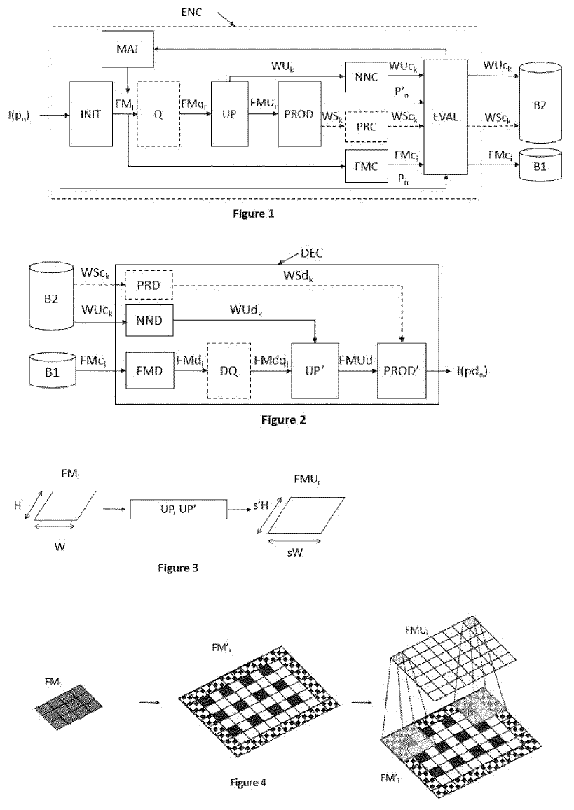

FIG. 2 shows schematically a decoding device DEC.

The decoding device DEC in FIG. 2 receives at the input a first group of encoded data organized into M feature maps FMcᵢ and oversampling parameters WUcₖ of an oversampling neural network. Optionally, the decoding device DEC receives the synthesis parameters WScₖ from a synthesis module, as illustrated by the dashed arrow.

This decoding device DEC comprises a neural network decoding module NND, a module FMD for decoding the feature maps, an optional module for decoding parameters of the synthesis module PRD, an optional inverse quantification module DQ, a module UP′ for oversampling the feature maps and a module PROD′ for synthesizing a signal and, according to the example shown, a digital image I(Pdn).

The maps decoded by the module FMD, M in number, are denoted FMdᵢ. It is however possible to organize the feature maps differently, for example by forming a single signal comprising, for each sample, a vector of M scalar values to be decoded, with no loss of generality. Even if the data are organized differently, in the following part of the document it is considered that there are M feature maps to be decoded.

The oversampling parameters decoded by the module NND are denoted WUdₖ. According to embodiments, some parameters WUdₖ may be predetermined, or obtained by decoding parameters WUcₖ using reference parameters known to the decoder.

The synthesis parameters decoded by the module PRD are denoted WSdₖ.

The module DQ optionally carries out an inverse quantification corresponding to the quantification carried out at the encoder. The module DQ produces the maps FMdqᵢ. The inverse quantification is not necessary if the quantifier Q of the encoder has performed a simple rounding of the real values submitted to it. Otherwise, the decoder performs the inverse operation of the quantifier Q. If the quantification is not necessary, FMdqᵢ=FMdᵢ.

The module UP′ carries out an oversampling of the feature maps. This module is configured by the parameters WUdₖ. This oversampling is carried out on at least one map, obtained after the module DQ, with a lower resolution than the resolution of the image. Some maps may not require oversampling, notably if their resolution is equal to that of the image to be decoded. Such maps are not processed by the module UP′ (in other words for example it is reduced to the identity function). At the output of the module UP′, a set of feature maps FMUdᵢ comprising the effectively oversampled maps and the maps not oversampled for which FMUdᵢ=FMdqᵢ is obtained. The embodiments previously described in relation to the encoder are applicable. The parameters WUdₖ are identical to the parameters WUₖ of the encoder if the encoding has been carried out without losses.

The module PROD′ is a synthesis module, for example a neural network or an inverse linear transformation (wavelet, DCT, etc.) defined by its parameters WSdₖ, designed to process the characteristic maps FMUdᵢ at the input, so as to generate the (decoded) synthesized image I(Pdₙ) at the output. The embodiments previously described in relation to the encoder are applicable. The parameters WSdₖ are identical to the parameters WSₖ of the encoder if the encoding has been carried out without losses. The parameters WSdₖ are optional, in other words the module PROD′ may use parameters known to the decoder.

As previously described in relation to FIG. 1, a positional decoding of the samples Pₙ of the signal may be carried out independently, which provides an advantage in terms of parallelization of the decoding. A vector (Pdₙ) representative of the sample Pₙ to be decoded is generated at the output as a function of its position within the image. According to one embodiment, the output vector is the triplet (R,G,B) of the decoded pixel Pdₙ, or the triplet (Y,U,V) of the decoded pixel Pdₙ when the image is in the format YUV 444, or a vector comprising four values Y, one value U and one value V, able to represent four pixels Pdₙ when the image is in the format YUV 420. When all the samples Pₙ of the signal have been decoded, this provides a reconstructed signal I(Pdₙ), according to one example an image I comprising N decoded samples in the form of N vectors (Pdₙ).

The decoding device DEC may be implemented by means of an electronic device comprising a processor and a memory, not shown; each of the modules mentioned hereinabove may then be implemented by the cooperation of the processor and of computer program instructions stored in the aforementioned memory and designed to carry out the functionalities of the module in question, notably as described hereinbelow, when these instructions are executed by the processor.

FIG. 3 illustrates an oversampling module (UP, UP′) used at the encoding and at the decoding in the framework of embodiments of the invention.

The purpose of the oversampling module is to produce a feature map containing more pixels than the input feature map. The input feature map is denoted FMᵢ, but may correspond to a map FM(d)qᵢ where, as explained in relation to FIGS. 1 and 2, d indicates that the map of index i of the group of feature maps has been initially encoded and decoded, and q that it has been (de)quantified (if necessary) by the module Q or DQ. The output feature map is denoted FMUᵢ. A map FMᵢ with a resolution W*H comprising W*H values, where W indicates the width of the map and H its height, is oversampled into a map FMUᵢ with a resolution s*W*s′*H. The scale parameters s and s′ are positive and greater than or equal to one. If the scale parameters have a value greater than one, the map FMᵢ intended for the encoding contains fewer encoded values than a map with a resolution identical to that of the image, which leads to a lowering of the rate required.

In one embodiment s=s′ in order to keep a proportionality ratio.

In a general framework, the oversampling module corresponds to at least one artificial neural network. It comprises weighting coefficients, biases and non-linearities specific to the operation of a neural network. This oversampling module may take the form of a simple convolution after insertion of zero values. More generally, a neural network may take the form of a succession of layers, where a layer may calculate y=f(Ax+b), where y and b are vectors of dimension N, x a vector of dimension M, A is a matrix of dimension M×N, and f is the activation function.

In one embodiment, s and s′ are written as integer powers of 2(s=2k, s′=2k′), which allows a more simple implementation by insertion of zero values into the map FMᵢ to be processed, as will be explained in relation to FIG. 4.

FIG. 4 illustrates one example of an oversampling module used in the framework of the invention.

The example in FIG. 4 shows an oversampling by transposed convolution (CT) operating on an input feature map FMᵢ of size 4×3 (W=4 and H=3 pixels) being subjected to an interpolation by a factor 2 in each direction (s=s′=2), hence the size of the output map FMUᵢ is 8×6.

The transposed convolution takes the form of a convolution core of dimension 3, in other words a matrix of coefficients of dimension 3*3.

In a first step, as illustrated in the middle of the figure, the map FMᵢ is interpolated by inserting pixels of zero value between each pair of pixels of the input map. 4 times more pixels on a grid denoted GR of size 8×6 pixels are therefore obtained. In a second step, this resulting grid is extended by a number of pixels (1 or 2 depending on the example) being a function of the size kxk of the convolution filter (k=3 in this example). In a general and known manner, this extension, or padding, is of size (k−1)/2 if k is odd. The padding can be seen in the figure in the hatched area. An extended grid FM′ᵢ of size 10×8 is obtained.

Then, a filtering is carried out using the core of the convolution, of size kxk (here k=3) operating on the extended grid FM′ᵢ. The core 3×3 is applied to the various positions of the grid in order to obtain the output map of the desired dimension. In FIG. 4, on the right, two positions of the convolution core are shown in transparent gray.

Any alternative (transposed) convolution operation may of course be applied. Similarly, any complementary operation available to those skilled in the art may be added to the transposed convolution: bias, stride (offset of the inverse convolution core at each iteration), dilation (spacing out of the input values supplied to the core), etc.

Similarly, any activation function available to those skilled in the art may be used (ReLU, sigmoid, Softmax, Softplus, Softsign, etc.).

According to the embodiment such as shown in FIG. 4, the convolution modules are composed of a 2D convolution, in other words the convolution core is applied jointly to the rows and the columns of the feature map.

According to another embodiment, they may be in a separable form. In this case, rather than performing the convolution on the two-dimensional feature map, a first unidimensional (1D) convolution operator of length Lh is applied to the rows, then a second convolution of length Lv is applied to the columns of the feature map obtained after the first operator, or vice versa. This implementation has the effect of reducing the storage from Lh*Lv for a given core to Lv+Lh and limits the complexity to Lh+Lw multiplications per value of feature map against Lh*Lv in the 2D case. The two 1D operators may be identical in length and have the same number of coefficients. The coefficients may be identical in the horizontal and vertical dimensions. As for the non-separable convolution, in the case of the transposed convolution, the 1D operators are applied after interpolation of the signal.

FIG. 5 shows examples of implementation of an oversampling module used in the framework of the invention.

A simple module, corresponding to the description provided hereinabove in relation to FIG. 4, is shown at (a). It comprises a transposed convolution CT. Preferably, it is followed by a bias and by a non-linearity.

A module comprising a convolution (C) followed by a transposed convolution (CT) is shown at (b). For example, the module C carries out a filtering pre-processing on the feature map at its initial resolution.

A module using a residual connection is shown at (c). According to this embodiment, the result of the transposed convolution (the map oversampled, for example, by a factor 2 in each dimension) is subjected to a new convolution the result of which is added to or subtracted from the oversampled map. The result is a residual map which advantageously corrects the oversampled signal.

A module including an attention element is shown at (d). Instead of the simple convolution shown on the lower branch of the preceding case (c), it comprises a convolution function (C2) followed by a sigmoid operator SGM representing the activation function of the sigmoid type. Generally speaking, an attention module allows a neural network to be trained to automatically associate with each element of a set a relevance relative to the other elements based on the context, from the example of C2. This allows a more localized processing than a pure residual system which would not have this relevance element.

The preceding elements, given by way of example, may of course be combined.

Notably, in one embodiment, the oversampling module may take the form of a succession of sampling sub-modules. For example, an oversampling by a factor s may be implemented by a succession of modules with smaller factors. An oversampling factor of s=6 may be obtained by cascading two modules with respective factors s1=2 and s2=3. A factor 8 may be obtained by three modules s1=2, s2=2 and s2=2. Thus, a single oversampling sub-module may be replicated in order to obtain oversamplings adapted to the various resolutions of the feature maps FMdᵢ. This embodiment has the advantage of limiting the number of modules and pooling the oversampling modules. Thus, the number of parameters of this network, and consequently their storage and/or transmission volume, together with the associated complexity of implementation, are reduced.

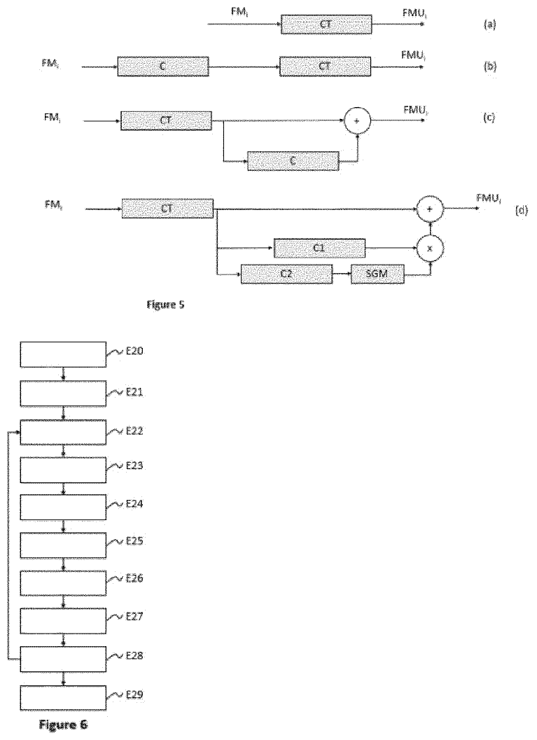

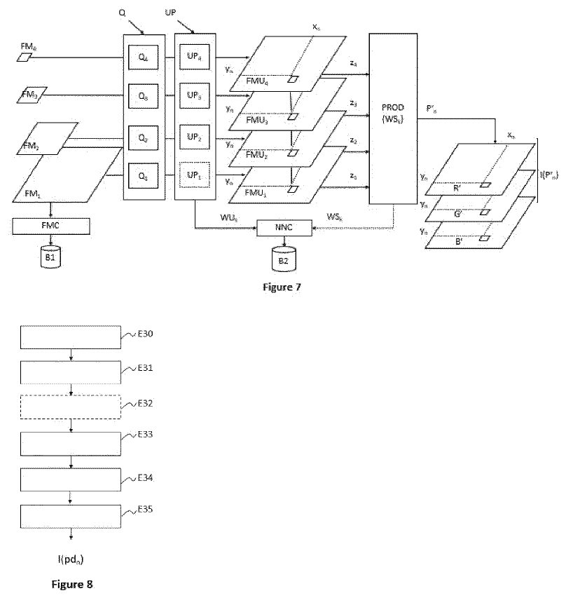

FIG. 6 is a flow diagram showing one example of an encoding method which may be implemented by the encoding device in FIG. 1.

According to this embodiment, the signal is a two-dimensional image, each sample to be encoded is therefore a pixel Pₙ with coordinates (xₙ, yₙ).

The encoding takes place in two main phases:

In a first phase, referred to as construction phase, a learning is undertaken in order to determine, for an input signal I(Pₙ), the values of the maps FMᵢ and of the parameters WUₖ of the oversampling neural network and, optionally, WSₖ of the production module in order to optimize an overall cost function. The learning is for example carried out by a gradient descent, followed by an update of the parameters of the oversampling neural network UP, optionally of the parameters of the synthesis module PROD, and of the values of the feature maps FMᵢ. As is known in the prior art, the cost function may be of the rate-distortion, or rate, or distortion type, or include a perceptual metric. For measuring the rate R, it is necessary to simulate the encoding of the maps FMᵢ, then to measure the associated encoding rate (the size of the stream B1). According to one embodiment, on ne simule pas the encoding of the parameters WUₖ and/or WSₖ is not simulated because their influence is less significant than that of the feature maps. According to one embodiment, the encoding of the parameters WUₖ and/or WSₖ is also simulated and the associated rate (the size of the stream B2) is measured. In order to measure the distortion D, it is necessary to simulate the encoding then the decoding of at least a part of the image I, so as to obtain at least one pixel P′ₙ resulting from an encoding then decoding simulation, then to measure the difference between this part of the image or of the set of images I (Pₙ) at the input and a corresponding encoded then decoded part of the image or of the set of images I (P′ₙ).

Then, during a second phase, referred to as encoding phase, the maps FMᵢ and the parameters WUₖ, and potentially WSₖ, are encoded so as to produce the encoded values FMcᵢ and WUcₖ (and potentially WScₖ) prior to transmission or storage. They constitute the compressed representation of the input signal I (Pₙ).

The steps of a method according to one embodiment of the invention will now be described.

During a step E20, a set of images I (Pₙ) to be encoded, comprising a plurality of N samples Pₙ, is supplied to the input of the method.

During a step E21, the M maps FMᵢ are initialized. Subsequently, the parameters WUₖ of the oversampling neural network UP and the values of the maps FMᵢ, and potentially the parameters WSₖ of the synthesis module PROD, must be optimized during the construction phase.

According to one embodiment, the maps FMᵢ have a lower or equal resolution to that of the input signal I (Pₙ) and hence comprise, for at least one of them, a number N′ of values to be encoded, less than N. According to one variant, the first map FMᵢ is at the resolution of the images and each subsequent map is at half the resolution of the preceding one.

According to one embodiment, several maps FMᵢ have the same resolution, lower than that of the input signal I (Pₙ). According to one embodiment, a single map FMᵢ comprises, for each sample, a vector of M scalar values to be decoded, with no loss of generality. Even if the data are organized differently, it is considered that there are M feature maps to be decoded.

According to one embodiment, the maps FMᵢ are initialized by the module INIT at predefined constant values.

According to another embodiment, the feature maps FMᵢ are initialized by the module INIT at a set of random real values.

The feature maps FMᵢ are subsequently updated, or refined, during a step E22, by the module MAJ for updating the encoder during its training.

During a step E23, the maps FMᵢ are quantified.

During a step E24, the maps FMᵢ are encoded by the module FMC of the encoder. During the construction phase, this operation is a encoding simulation. During the encoding phase, this operation is an effective encoding and the encoded values form the stream B1. The simulation may be identical to the effective encoding, but it may also be different (for example, simplified). For this encoding, an entropy encoding of the quantified values is for example used.

In one embodiment, the maps FMᵢ are encoded in the order (FM₁ , FM₂ , . . . , FM₄), and the variables of each map in a predefined, for example lexicographic, order. Each map undergoes an entropy encoding. The entropy encoding produces a compressed stream B1 whose rate is measured later during a step E28 or E29.

During a step E25, the M maps FMᵢ are oversampled by the module FMU so as to generate maps FMUᵢ at the resolution of the images of the input sequence. At least one map FMᵢ has a lower resolution than that of the images to be encoded and the oversampling operation is carried out so that the oversampled map FMUᵢ comprises the same number of samples as the images to be encoded. The oversampling consists in adding values into the maps FMU; and in processing them by at least one neural network so as to reach the resolution of the input images. The oversampled maps are not encoded and are solely used to supply the module PROD.

The structure and the parameters WUₖ of the oversampling neural network are initialized for example during the first iteration of this step. These parameters are subsequently updated, or refined, in the course of the construction phase, during further iterations of the method.

According to one embodiment, the parameters of the oversampling network are initialized by known predefined values so as to give a satisfactory result (for example, subsequent to a training on a corpus of images).

According to another embodiment, the parameters of the oversampling neural network are initialized by a set of random values.

According to one embodiment, M maps FMUᵢ are generated.

According to one embodiment, each map FMᵢ is transformed into a map FMUᵢ.

During a step E26, the module PROD is called up in order to synthesize the image I(P′ₙ). According to one embodiment, the module PROD is a neural network of the MLP or convolutional type, or a combination of the two, which transforms an input vector into an output vector representative of the sample being processed, for example a pixel. For example, the extraction is carried out in the oversampled maps as a function of the coordinates (xₙ, yₙ) of the sample Pₙ of the input signal. According to another example, the extraction is implemented by block in the maps in order to produce a set of pixels at the output. In this case, the input vector corresponds to the block. The structure and the parameters WSₖ of the synthesis neural network are initialized for example during the first iteration of this step. These parameters are subsequently updated, or refined, in the course of the construction phase, during further iterations of the method.

The samples to be encoded are for example processed in a sequential order, from n=1 to n=N.

During a step E27, the parameters WSₖ of the synthesis neural network of the module PROD, if they exist, and the parameters WUₖ of the oversampling neural network, are quantified and encoded. During the construction phase, this operation is an encoding simulation. During the encoding phase, this operation is an effective encoding and the encoded values form the stream B2. The simulation may be identical to the effective encoding, but it may also be different (for example, simplified). For this purpose any known technique may be used, for example the neural network encoding standard provided by the standard MPEG-7 part 17, also referred to as NNR (Neural Network Representation). It will be noted that, in this case, the quantity of degradation that the encoding causes to the weights WUₖ, and optionally WSₖ, has to be chosen.

According to one embodiment, the stream B2 is transmitted. According to another embodiment, the stream B2 is stored in memory, for example in a ROM or in a RAM.

This storage space may contain a bank of parameters allowing oversampling network variants to be constituted. For example, several convolutions (simple interpolators such as cubic, linear interpolations or extended to two dimensions, etc.), several residual convolutions or convolutions with attention adapted to specific contents (directional images, graphical images, satellite images, etc.) may be stored; an indicator may then be inserted into the stream for informing the decoder of the network to be used.

According to one embodiment, some parameters WUcₖ of the oversampling network UP may be expressed in relation with a reference network stored in memory. This has the advantage of reducing the space needed for the storage or the transmission of the network. For example, a layer of the oversampling network may be copied from the reference network, the weights of a layer may be encoded in differential mode, in other words a corrective value is applied by addition or multiplication to each weight (convolution, bias) of the reference network. These corrective values may be transmitted or stored efficiently by means of an entropy code. Thus, the oversampling network is adapted, with little additional information, to the nature of the signal contained in the feature map and to the image or to the processed images.

The two embodiments mentioned hereinabove may be combined: a reference indicator may then be inserted into the stream for informing the decoder of the reference network to be used, and the parameters received are used to reconstruct the oversampling network from the reference network to be used.

During a step E28, a performance measurement is evaluated.

For this purpose, the encoding simulation rates associated with the feature maps (simulation of the stream B1 by encoding the maps FMᵢ) and, optionally, with the parameters of the neural network(s) (simulation of the stream B2 by encoding the parameters WUₖ and, optionally, WSₖ) are measured.

According to one embodiment, the cost function is of the rate-distortion type, denoted (D+L*R), where D is for example the quadratic error measured between the input signal and the decoded signal (or the error measured on a sub-set of samples of the signal). According to another example, D is calculated using a perceptive function such as the SSIM (for Structural SIMilarity), or MSSSIM (for Multi-scale Structural SIMilarity). According to one embodiment, R is the simulated rate of the stream B1; according to another embodiment, R is the total rate used for encoding this image, in other words the sum of the simulated rates of B1 and B2. L is a parameter which governs the rate-distortion compromise. Other cost functions are possible.

As long as the cost function has not reached its minimum, the measurement of performance is not satisfactory, and the method is iterated from the step E22. This minimization may be carried out by a known mechanism such as a gradient descent with update of the parameters during the step E22 for the values of the feature maps and E25, E26 for the parameters of the network(s).

During a step E29, if the cost function has reached its minimum, the training is stopped. If an encoded version corresponding to the last simulation of the parameters of the oversampling neural network (WUₖ), optionally synthesis neural network (WSₖ), and of the feature maps (FMᵢ) is available, the streams B1 and B2 may be formed from these. According to another embodiment, the effective encoding of the updated parameters of the neural network(s) and of the values of the feature maps (FMᵢ) is carried out at this step in order to produce the encoded parameters WUcₖ (optionally WScₖ) and FMcᵢ which constitute streams B1 and B2. The streams B1 and B2 may be concatenated to produce a final stream. According to one embodiment, the stream B2 of the encoded parameters of the neural network(s) is stored or transmitted before the stream B1, in order to be able to be decoded before the stream B1.

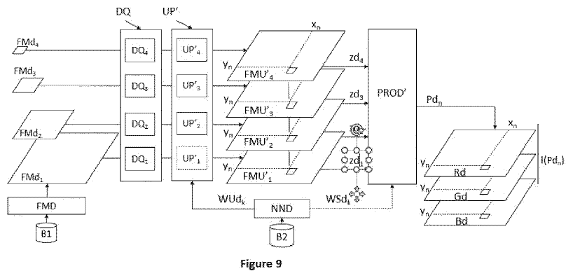

FIG. 7 shows an illustration of an encoding method used in one embodiment of the invention.

In this embodiment, there are four maps FMᵢ generated. In a preferred embodiment, there are seven of them.

The first map FM₁ has the same resolution as the image I (Pₙ), and hence comprises W×H variable or scalar values, where W represents the width of the image in pixels, and H its height. The second map FM₂ has half the resolution (in each dimension) of the map FM₁ . Each additional map has half the resolution of the preceding map. This structure allows the number of variables of the feature maps to be reduced, which facilitates the encoding and the training while at the same time minimizing the cost of encoding. Other types of structure are possible, for example a reduction factor different from a half may be used between the maps (a quarter, or a third, etc.).

According to this embodiment, the maps FMᵢ are quantified by the module Q. Each map has its own quantification sub-module Qᵢ. In another embodiment, the quantification module is common to all the maps.

According to this embodiment, the maps FMqᵢ are oversampled by the module UP, with the exception of FMq₁ which is already at the resolution of the output image. The module UP₁ is reduced to the identity function (or non-existent).

In one embodiment, each map has its own oversampling sub-module UPᵢ which allows it to go from the resolution of the map FMᵢ to the resolution of the image. Thus, the map FM₂ is oversampled by the module UP₂ by a factor 2 in each dimension, according to a method illustrated in relation to FIGS. 3 to 5. The map FM₃ is oversampled by a factor 4, which may be implemented by two successive oversamplings with a factor 2, in each dimension, and the map FM₄ by a factor 8 in each dimension.

The resulting maps FMUᵢ have the same resolution as the image I(Pₙ) and hence each comprise W×H values, where W represents the width of the image in pixels and H its height (N=W×H).

In another embodiment, the oversampling module is common to all the maps; for example, a sub-module with a factor 2 may be cascaded and/or shared by several maps.

In the embodiment illustrated, the synthesis module PROD is a synthesis neural network of the MLP or convolutional type, or a combination of the two, and a vector Zₙ (z₁. . . z₄) is formed using values extracted from the maps FMUᵢ situated at the coordinates (xₙ, yₙ) of the current pixel Pₙ. The vector Zₙcomposed of the values (quantified) extracted from the maps FMUᵢ is processed by the synthesis neural network of the module PROD in order to generate a second vector at the output. According to the example, the output vector is the triplet (R,G,B) of the pixel P′ₙ encoded (given that the feature maps used for the extraction correspond to those that are encoded in the stream) then decoded (in other words here generated, or produced, by the neural network PROD). The triplet is inserted into the decoded image I (P′ₙ) at the positions (xₙ, yₙ) of the color components (R', G', B') and may be used by the module for evaluating the quality, by comparison with the input image I (Pₙ).

FIG. 8 is a flow diagram representing one example of a decoding method which may be implemented by the decoding device in FIG. 2.

The decoding described relates to a sub-sequence of images comprising at least one image to be decoded.

During a step E30, the streams B1 and B2 are extracted from the encoded stream. They respectively contain, for a current sub-sequence of the sequence, the encoded representations of the current maps FMcᵢ and of the oversampling parameters WUcₖ of the oversampling neural network UP, optionally of the synthesis parameters WScₖ of the synthesis module.

According to one embodiment, the stream B2 is received. According to another embodiment, the stream B2 is stored in memory, for example in a ROM or in a RAM. According to what has been described for the encoder, this storage space may contain a bank, or plurality, of parameters allowing oversampling network variants to be constituted. An indicator may then be read in the stream so as to inform the decoder of the network to be used or to be constructed from a combination of parameters.

According to one embodiment, the parameters WUcₖ of the oversampling network may be decoded in relation with a reference network stored in memory. The examples described for the encoder are applicable. For example, the parameters received are corrective values relating to the reference network, which may be decoded by means of an entropy code and combined with the parameters of the reference network.

The two embodiments mentioned hereinabove may be combined: a reference indicator may then be read in the stream for informing the decoder of the reference network to be used, and the parameters received are used to reconstruct the oversampling network from the reference network.

During a step E31, the M maps FMdᵢ are generated by decoding the values FMcᵢ. For this decoding, an entropy decoder is for example used.

According to embodiments such as described for the encoder:
the maps FMdᵢ have a resolution less than or equal to that of the signal I (Pdₙ) to be reconstituted.
several maps FMdᵢ have the same resolution, lower than the resolution of the signal.
a single map FMdᵢ comprises, for each sample, a vector of M scalar values to be decoded. Even if the data are organized differently, it is considered that there are M feature maps to be decoded.

During a step E32, according to one embodiment, the maps FMdᵢ are de-quantified.

During a step E33, the oversampling neural network of the module UP is decoded. The parameters WUdₖ of the oversampling neural network UP′, and potentially the parameters WSdₖ of the synthesis neural network of the module PROD, are generated by decoding the values WUcₖ and WScₖ of the stream B2. For this purpose, any known decoding technique may be used corresponding to that used by the encoder for the encoding, for example a format analogous to that of the standard MPEG-7 NNR. The synthesis neural network of the module PROD′ is similar to the synthesis network of the module PROD, in other words it has the same structure and comprises the same parameters, except for the encoding which may be implemented with or without losses. Similarly, the oversampling neural network UP′ is similar to the oversampling network UP, in other words it has the same structure and comprises the same parameters, except for the encoding which may be implemented with or without losses.

According to one embodiment, the stream B2 is decoded before the stream B1, so that the oversampling neural network UP, and potentially the synthesis neural network PROD, will be available prior to starting to decode the samples.

During a step E34, the M decoded maps FMdᵢ are oversampled by the module UP′ so as to generate maps FMUdᵢ at the resolution of the images of the input sequence. At least one map FMdᵢ has a lower resolution than that of the images to be encoded and the oversampling operation is carried out so that the oversampled map FMUdᵢ comprises the same number of samples as the images to be decoded. The oversampling consists in adding values into the maps FMdᵢ and in processing them by a neural network in order to reach the resolution of the output images. This step is similar to the step E25 which has been described for the encoder in relation to FIG. 6, and the embodiments are applicable. Notably:

According to one embodiment, M maps FMUdᵢ are generated.

According to one embodiment, each map FMdᵢ is oversampled as a map FMUdᵢ.

According to one embodiment, at least one map FMdᵢ has a lower resolution than that of the images to be encoded and the oversampling operation is carried out so that the oversampled map FMUdᵢ comprises the same number of samples as the output image.

During a step E35, the module PROD is called up so as to generate a synthesis of the decoded samples from the oversampled feature maps. According to one embodiment, the module PROD is a neural network of the MLP or convolutional type, or a combination of the two, which transforms an input vector into an output vector representative of the sample being processed, for example, a pixel. For example, the extraction is carried out in the oversampled maps as a function of the coordinates (xₙ, yₙ) of the sample Pₙ of the input signal.

This step is similar to the step E26 which has been described for the encoder in relation to FIG. 6, and the embodiments are applicable.

The samples to be decoded are for example processed in a sequential order, from n=1 to n=N.

When all the samples of the signal have been processed, the decoded signal corresponding for example to the image I (Pdₙ) is available.

FIG. 9 shows an illustration of a decoding method used in one embodiment of the invention.

In this embodiment, there are four decoded maps FMdᵢ. In a preferred embodiment, there are seven of them.

In this embodiment, the first map FMdᵢ has the same resolution as the image I, and therefore comprises W×H variable values, where W represents the width of the image in pixels, and H its height. The second map FMd₂ has half the resolution (in each dimension) of the map FMd₁. Each additional map has half the resolution of the preceding map. This structure allows the number of variables of the feature maps to be reduced which facilitates the decoding while at the same time minimizing the cost of encoding. Other types of structure are possible, for example a different reduction factor than a half between the maps (a quarter, or a third, etc.) may be used.

According to this embodiment, the maps FMdᵢ are de-quantified by the module DQ. Each map has its own quantification sub-module DQᵢ. In another embodiment, the inverse quantification module is common to all the maps. In another embodiment, it doesn't exist.

According to this embodiment, the maps FMqᵢ are oversampled by the module UP′, with the exception of FMq₁ which is already at the resolution of the output image. The module UP₁ is reduced to the identity function (or does not exist).

In one embodiment, each map has its own oversampling sub-module UPᵢ which allows it to go from the resolution of the map FMdᵢ to the resolution of the image. The map FMd₂ is oversampled by the module UP′2 with a factor 2 in each dimension, according to a method illustrated in relation to FIGS. 3 to 5. The map FMd₃ is oversampled by a factor 4, which may be implemented by two successive oversamplings with a factor 2, in each dimension, and the map FMd₄ by a factor 8 in each dimension.

The resulting maps FMUdᵢ have the same resolution as the image I (Pdₙ) and hence each comprise W×H values, where W represents the width of the image in pixels and H its height (N=W×H).

In another embodiment, as described for the encoder, the oversampling module is common to all the maps; for example, a sub-module with a factor 2 may be cascaded and/or shared by several maps.

In the embodiment illustrated, the module PROD′ is a synthesis neural network of the MLP or convolutional type, or a combination of the two, and a vector Zdₙ (zd₁. . . zd₄) is constituted using the values extracted from the maps FMUᵢ situated at the coordinates (xₙ, yₙ) of the current pixel Pₙ. The vector Zdₙ is processed by the synthesis neural network of the module PROD′ so as to generate the triplet (R, G, B) at the output representative of the sample Pdₙ to be decoded. The triplet (R, G, B) is inserted into the decoded image I (Pdₙ) at the coordinates (xₙ, yₙ) into the color components (Rd, Gd, Bd).

1-16. (canceled)

17. An encoding method for encoding at least one image comprising a plurality of samples to be encoded, the method being implemented by an encoding device and comprising:
constructing, comprising:
constructing at least one feature map with a lower resolution than a resolution of said image;
oversampling said at least one lower resolution feature map using at least one oversampling neural network, defined by one set of oversampling parameters so as to obtain an oversampled map at the resolution of said image;
generating said image from said at least one oversampled map; and
updating at least one value of said at least one feature map and/or at least one oversampling parameter, as a function of an encoding performance measurement; and
encoding said at least one lower resolution feature map.

18. The encoding method as claimed in claim 17 wherein said generating said at least one image uses a synthesis module defined by a set of synthesis parameters, designed to generate a sample of the image using data extracted from said at least one oversampled feature map at positions defined by that of said sample within the image.

19. The encoding method as claimed in claim 18, wherein the method comprises encoding said set of synthesis parameters and/or said set of oversampling parameters.

20. A decoding method for decoding at least one image, from a binary stream comprising a plurality of samples to be decoded, the method being implemented by a decoding device and comprising:
obtaining, by decoding, at least one feature map representative of said image, with a lower resolution than that of said image;
obtaining at least one oversampled feature map at the resolution of said image by oversampling said at least one lower resolution feature map using at least one oversampling neural network; and
generating said image from said at least one oversampled map.

21. The decoding method as claimed in claim 20, furthermore comprising:
obtaining a set of oversampling parameters representative of said oversampling neural network.

22. The decoding method as claimed in claim 21, wherein at least a part of the set of oversampling parameters is decoded from data of said binary stream.

23. The decoding method as claimed in claim 21, wherein at least a part of the set of oversampling parameters is obtained from predetermined values.

24. The decoding method as claimed in claim 21, wherein at least a part of the set of oversampling parameters is decoded as a function of reference parameters.

25. The decoding method as claimed in claim 21, wherein the set of oversampling parameters is representative of a plurality of oversampling neural networks, an oversampling neural network being used for oversampling said at least one lower resolution feature map.

26. The decoding method as claimed in claim 20, wherein an oversampling neural network is used for oversampling at least two lower resolution feature maps.

27. The decoding method as claimed in claim 20, wherein an oversampling neural network is used for oversampling at least one already oversampled feature map.

28. The decoding method as claimed claim 20, wherein said at least one lower resolution feature map is oversampled in at least two dimensions, and a separate oversampling is used for each dimension.

29. The decoding method as claimed in claim 20, wherein said generating said at least one image uses a synthesis neural network designed to generate a sample of the image using data extracted from the oversampled feature maps at positions defined by that of said sample within the image.

30. An encoding device for encoding at least one image comprising a plurality of samples to be encoded, wherein said encoding device comprises:
at least one processor; and
at least one non-transitory computer readable medium comprising instructions stored thereon which when executed by the at least one processor configure the encoding device to implement:
constructing, comprising:
constructing at least one feature map with a lower resolution than the resolution of said image;
oversampling of said at least one lower resolution feature map using at least one oversampling neural network, defined by a set of oversampling parameters, so as to obtain at least one oversampled map at the resolution of said image;
generating said image from said at least one oversampled feature map; and
updating at least one value of said at least one feature map from said group and/or at least one oversampling parameter, as a function of an encoding performance measurement; and
encoding said at least one lower resolution feature map.

31. A decoding device for decoding at least one image, from a binary stream, comprising a plurality of samples to be decoded, wherein said decoding device comprises:
at least one processor; and
at least one non-transitory computer readable medium comprising instructions stored thereon which when executed by the at least one processor configure the decoding device to implement:
obtaining, by decoding, at least one feature map representative of said image, with a resolution lower than that of said image;
obtaining at least one oversampled feature map at the resolution of said image by oversampling said at least one lower resolution feature map using at least one oversampling neural network; and
generating said at least one image from said at least one oversampled feature map.

32. A non-transitory computer readable medium comprising a computer program stored thereon comprising instructions for executing the encoding method as claimed in claim 17 when said program is executed by at least one processor of the encoding device.

33. A non-transitory computer readable medium comprising a computer program stored thereon comprising instructions for executing the decoding method as claimed in claim 20 when said program is executed by at least one processor of the decoding device.
